(19) United States
(12) Patent Application Publication
(10) Pub. No.: US 2012/0247412 A1
(43) Pub. Date: Oct. 4, 2012

(54) Method for improving fuel economy of a heavy duty diesel engine

(75) Inventors: Jeffrey J. Toman, (US); Gaurav Bhalla, (US); Elaine S. Yamaguchi, (US); Yat Fat Suen, (US); Trevor Miller, (US); Francois Simard, (US)

(73) Assignee: Chevron Oronite Company LLC, San Ramon, CA (US)

(21) Appl. No.: 13/065,864

(22) Filed: Mar. 31, 2011

(51) Int. Cl. F02M 25/00

(52) U.S. Cl. 123/1 A

(57) ABSTRACT

Disclosed is a method for improving the fuel economy of a heavy duty diesel engine which produces a heavily sooted lubricating oil composition during the engine's normal operation. The method involves introducing lubricating the heavy duty diesel engine with a heavy duty diesel engine lubricating oil composition comprising (a) a major amount of an oil of lubricating viscosity; and (b) a minor effective amount of an ashless friction modifier comprising a reaction product of a C₄ to about C₇₅ fatty acid ester and a mono- or dialkanolamine.

### BACKGROUND OF THE INVENTION

1. Technical Field

The present invention generally relates to a method for improving fuel economy of a heavy duty diesel engine.

2. Description of the Related Art

The heavy duty trucking market employs the diesel engine as its preferred power source due to its excellent longevity. The fuel consumption of heavy duty diesel engines is of great importance to fleet operators since fuel costs constitute up to 30% of operating costs.

A heavy duty diesel engine generally produces more soot in the engine during operation than a light or medium duty diesel engine. The greater amount of soot in the heavy duty diesel engine will have an effect on the fuel economy of the engine. Improvements in the fuel economy of the heavy duty diesel engine have generally been achieved either through new engine design or through new approaches to formulating lubricating oils. Lubricant optimization is preferred over engine hardware changes due to its comparative lower cost per unit fuel efficiency and possibility for backward compatibility with older engines.

Accordingly, to improve fuel efficiency in heavy duty diesel engines, there has been a drive to develop new components which improve the frictional properties of the heavy duty diesel engine lubricating oil composition.

EP 1323816 (“the '816 application”) discloses that because heavy duty diesel engines operate more under hydrodynamic conditions than passenger car engines, friction reducers will not be effective in reducing engine friction losses in heavy duty diesel engines. The '816 application further discloses that friction reducers effective in improving the fuel economy performance of heavy duty diesel engines have been discovered. The '816 application goes on to disclose that the friction reducers can be broadly divided into two categories. These categories are (1) polar compounds capable of being adsorbed onto metal surfaces that have a polar head group and oleophilic hydrocarbyl chain; and (2) oil-soluble additives that deposit molybdenum disulfide onto the metal surface. The polar compounds capable of being adsorbed onto metal surfaces that have a polar head group and oleophilic hydrocarbyl chain can be further subdivided into two categories: (A) nitrogen-containing compounds, such as amines, imides and amides, and (B) oxygen-containing compounds, such as fatty acids and full or partial esters thereof. The nitrogen-containing compounds disclosed in the '816 application include (i) alkylene amines; (ii) alkanolamines; (iii) alkyl amides in which the N-alkyl groups have from 1 to 25 carbon atoms; and (iv) alkanolamides. The oxygen-containing compounds disclosed in the '816 application include (i) carboxylic acids having 1 to 25 carbon atoms; (ii) full and partial esters thereof of di- and/or polyhydric alcohols; and (iii) metal salts thereof. The examples of the '816 application exemplify glycerol monooleate and trinuclear molybdenum dithiocarbamate as friction modifiers.

U.S. Pat. No. 4,293,432 discloses a method of friction reduction in an internal combustion engine crankcase by using a formulated motor oil containing an ashless dispersant and about 0.1 to 1.5 weight percent of a reaction product of a fatty acid and monoethanolamine.

U.S. Patent Application Publication No. 2004/0192565 discloses a method for improving the fuel economy in an internal combustion engine such as a gasoline or diesel internal combustion engine employing a lubricating oil composition containing an ashless friction modifier which is the reaction product of C₄ to C₇₅ fatty acid ester and alkanolamine.

Heretofore, there has been no recognition or appreciation that the fuel economy in a heavy duty diesel engine prone to heavy sooting during the engine's normal operation can be appreciably improved by use of a heavy duty diesel engine lubricating oil composition containing a friction modifier which is the reaction product of C₄ to C₇₅ fatty acid ester and a mono- or dialkanolamine. Accordingly, it would be desirable to develop methods for improving the fuel economy of a heavy duty diesel engine.

### SUMMARY OF THE INVENTION

In accordance with one embodiment of the present invention, there is provided a method for improving the fuel economy of a heavy duty diesel engine which produces a heavily sooted lubricating oil composition during the engine's normal operation, the method comprising lubricating the heavy duty diesel engine with a heavy duty diesel engine lubricating oil composition comprising (a) a major amount of an oil of lubricating viscosity; and (b) a minor effective amount of an ashless friction modifier comprising a reaction product of a C₄ to about C₇₅ fatty acid ester and a mono- or dialkanolamine.

In accordance with a second embodiment of the present invention, there is provided a method for improving the fuel economy of a heavy duty diesel engine operating under increasing levels of soot during the engine's normal operation, which comprises lubricating the heavy duty diesel engine with a heavy duty diesel engine lubricating oil composition comprising (a) a major amount of an oil of lubricating viscosity; and (b) a minor effective amount of an ashless friction modifier comprising a reaction product of a C₄ to about C₇₅ fatty acid ester and a mono- or dialkanolamine.

In accordance with a third embodiment of the present invention, there is provided the use of a heavy duty diesel engine lubricating oil composition comprising (a) a major amount of an oil of lubricating viscosity; and (b) a minor effective amount of an ashless friction modifier comprising a reaction product of a C₄ to about C₇₅ fatty acid ester and a mono- or dialkanolamine in improving the fuel economy of a heavy duty diesel engine which produces a heavily sooted lubricating oil composition during the engine's normal operation.

Among other factors, the present invention is based on the discovery that the fuel economy of a heavy duty diesel engine which produces a heavily sooted lubricating oil composition during the engine's normal operation is improved by employing a heavy duty diesel engine lubricating oil composition containing (a) a major amount of an oil of lubricating viscosity; and (b) an effective amount of an ashless friction modifier comprising a reaction product of a C₄ to about C₇₅ fatty acid ester and a mono- or dialkanolamine. The discovery is unexpected as the ashless friction modifier which is a reaction product of a C₄ to about C₇₅ fatty acid ester and a mono- or dialkanolamine performed significantly worse than molybdenum dithiocarbamate, which is a known friction modifier as disclosed, e.g., in the '816 application, in reducing friction in an unsooted or very lightly sooted environment, i.e., a soot loading of less than 2 wt. %. However, the ashless friction modifier which is a reaction product of a C₄ to about C₇₅ fatty acid ester and a mono- or dialkanolamine performed significantly better than the same molybdenum dithiocarbamate in reducing friction in a heavily sooted environment.

### DETAILED DESCRIPTION OF THE PREFERRED EMBODIMENTS

The present invention is directed to a method for improving the fuel economy of a heavy duty diesel engine which produces a heavily sooted lubricating oil composition during the engine's normal operation, the method comprising lubricating the heavy duty diesel engine with a heavy duty diesel lubricating oil composition comprising (a) a major amount of an oil of lubricating viscosity; and (b) a minor effective amount of an ashless friction modifier comprising a reaction product of a C₄ to about C₇₅ fatty acid ester and a mono- or dialkanolamine.

The primary service classes for a heavy duty diesel engine are light, medium, and heavy heavy-duty diesel engines as disclosed in US 40 CFR 86.090-2. The classification is based on factors such as vehicle gross vehicle weight (GVW), vehicle usage and operating patterns, other vehicle design characteristics, engine horsepower, and other engine design and operating characteristics. The following is a general description of the primary service classes for a heavy duty diesel engine:

(1) Light heavy duty diesel engines usually are non-sleeved and not designed for rebuild; their rated horsepower generally ranges from 70 to 170. Vehicle body types in this group may include any heavy-duty vehicle built for a light-duty truck chassis, van trucks, multi-stop vans, recreational vehicles, and some single axle straight trucks. Typical applications of such engines include personal transportation, light-load commercial hauling and delivery, passenger service, agriculture, and construction. The engines in this group are normally used in vehicles whose GVW is normally less than 19,500 lbs.

(2) Medium heavy duty diesel engines may be sleeved or non-sleeved and may be designed for rebuild; their rated horsepower generally ranges from 170 to 250. Vehicle body types in this group may include school buses, tandem axle straight trucks, city tractors, and a variety of special purpose vehicles such as small dump trucks, and trash compactor trucks. Typical applications of such engines include commercial short haul and intra-city delivery and pickup. The engines in this group are normally used in vehicles whose GVW varies from 19,500 to 33,000 lbs.

(3) Heavy heavy duty diesel engines are sleeved and designed for multiple rebuilds; their rated horsepower generally exceeds 250. Vehicles body types in this group may include tractors, trucks, and buses used in inter-city, long-haul applications. The engines in this group are normally used in vehicles whose GVW exceed 33,000 lbs.

In general, a typical soot loading for a used heavy duty diesel engine lubricating oil composition during the normal operation of a heavy duty diesel engine such as after 20,000 miles is at least 2 wt. %. In one embodiment, a soot loading for a used heavy duty diesel engine lubricating oil composition during the normal operation of a heavy duty diesel engine such as after 20,000 miles is at least 2 wt. % to no more than about 9 wt. %. In one embodiment, a soot loading for a used heavy duty diesel engine lubricating oil composition during the normal operation of a heavy duty diesel engine such as after 20,000 miles is at least 2 wt. % to no more than about 5 wt. %.

In one embodiment, a soot loading for a used heavy duty diesel engine lubricating oil composition during the normal operation of a heavy duty diesel engine such as after 20,000 miles is at least about 3 wt. % to no more than about 9 wt. %. In one embodiment, a soot loading for a used heavy duty diesel engine lubricating oil composition during the normal operation of a heavy duty diesel engine such as after 20,000 miles is at least about 3 wt. % to no more than about 5 wt. %. In one embodiment, a soot loading for a used heavy duty diesel engine lubricating oil composition during the normal operation of a heavy duty diesel engine such as after 20,000 miles is at least about 3 wt. % to no more than about 4 wt. %.

The soot loading for a used heavy duty diesel engine oil is determined by ASTM D5697-10a, Appendix A4.

In one embodiment, the heavy duty diesel engine lubricating oil compositions according to the present invention contain from about 0.06 wt-% to about 0.15 wt. % of phosphorus, based on the total weight of the heavy duty diesel engine lubricating oil composition. In one embodiment, the heavy duty diesel engine lubricating oil compositions according to the present invention contain from about 0.08 wt. % to about 0.12 wt. % of phosphorus, based on the total weight of the heavy duty diesel engine lubricating oil composition.

In one embodiment, a heavy duty diesel engine lubricating oil composition according to the present invention will have a sulfated ash content of no more than about 1.5 wt. % as determined by ASTM D 874. In one embodiment, a heavy duty diesel engine lubricating oil composition according to the present invention for use in heavy duty diesel fueled engines has a sulfated ash content of about 0.8 to about 1.5 wt. % as determined by ASTM D 874.

In another embodiment, a heavy duty diesel engine lubricating oil composition according to the present invention contains relatively low levels of sulfur, i.e., not exceeding about 0.8 wt. %, based on the total weight of the heavy duty diesel engine lubricating oil composition. In another embodiment, a heavy duty diesel engine lubricating oil composition according to the present invention contains about 0.25. wt. % to about 0.6 wt. %, based on the total weight of the heavy duty diesel engine lubricating oil composition.

The oil of lubricating viscosity for use in a heavy duty diesel engine lubricating oil compositions of this invention, also referred to as a base oil, is typically present in a major amount, e.g., an amount greater than 50 wt. %, preferably greater than about 70 wt. %, more preferably from about 80 to about 99.5 wt. % and most preferably from about 85 to about 98 wt. %, based on the total weight of the composition. The expression “base oil” as used herein shall be understood to mean a base stock or blend of base stocks which is a lubricant component that is produced by a single manufacturer to the same specifications (independent of feed source or manufacturer's location); that meets the same manufacturer's specification; and that is identified by a unique formula, product identification number, or both. The base oil for use herein can be any presently known or later-discovered oil of lubricating viscosity used in formulating a heavy duty diesel engine lubricating oil compositions for any and all such applications. Additionally, the base oils for use herein can optionally contain viscosity index improvers, e.g., polymeric alkylmethacrylates; olefinic copolymers, e.g., an ethylene-propylene copolymer or a styrene-butadiene copolymer; and the like and mixtures thereof.

As one skilled in the art would readily appreciate, the viscosity of the base oil is dependent upon the application. Accordingly, the viscosity of a base oil for use herein will ordinarily range from about 2 to about 2000 centistokes (cSt) at 100° Centigrade (C.). Generally, individually the base oils used herein will have a kinematic viscosity range at 100° C. of about 5.5 cSt to about 10 cSt. In one embodiment, the base oils used herein will have a kinematic viscosity range at 100° C. of about 4 cSt to about 12 cSt. The base oil will be selected or blended depending on the desired end use and the additives in the finished oil to give the desired grade of oil, e.g., a heavy duty diesel engine lubricating oil composition having an SAE Viscosity Grade of 0 W, 0 W-20, 0 W-30, 0 W-40, 0 W-50, 0 W-60, 5 W, 5 W-20, 5 W-30, 5 W-40, 5 W-50, 5 W-60, 10 W, 10 W-20, 10 W-30, 10 W-40, 10 W-50, 15 W, 15 W-20, 15 W-30, 15 W-40, 30, 40 and the like.

Base stocks may be manufactured using a variety of different processes including, but not limited to, distillation, solvent refining, hydrogen processing, oligomerization, esterification, and rerefining. Rerefined stock shall be substantially free from materials introduced through manufacturing, contamination, or previous use. The base oil of the lubricating oil compositions of this invention may be any natural or synthetic lubricating base oil. Suitable hydrocarbon synthetic oils include, but are not limited to, oils prepared from the polymerization of ethylene or from the polymerization of 1-olefins to provide polymers such as polyalphaolefin or PAO oils, or from hydrocarbon synthesis procedures using carbon monoxide and hydrogen gases such as in a Fischer-Tropsch process. For example, a suitable base oil is one that comprises little, if any, heavy fraction; e.g., little, if any, lube oil fraction of viscosity 20 cSt or higher at 100° C.

The base oil may be derived from natural lubricating oils, synthetic lubricating oils or mixtures thereof. Suitable base oil includes base stocks obtained by isomerization of synthetic wax and slack wax, as well as hydrocracked base stocks produced by hydrocracking (rather than solvent extracting) the aromatic and polar components of the crude. Suitable base oils include those in all API categories I, II, III, IV and V as defined in API Publication 1509, 16^{th} Edition, Addendum I, October, 2009. Group IV base oils are polyalphaolefins (PAO). Group V base oils include all other base oils not included in Group I, II, III, or IV. Although Group II, III and IV base oils are preferred for use in this invention, these base oils may be prepared by combining one or more of Group I, II, III, IV and V base stocks or base oils.

Useful natural oils include mineral lubricating oils such as, for example, liquid petroleum oils, solvent-treated or acid-treated mineral lubricating oils of the paraffinic, naphthenic or mixed paraffinic-naphthenic types, oils derived from coal or shale, animal oils, vegetable oils (e.g., rapeseed oils, castor oils and lard oil), and the like.

Useful synthetic lubricating oils include, but are not limited to, hydrocarbon oils and halo-substituted hydrocarbon oils such as polymerized and interpolymerized olefins, e.g., polybutylenes, polypropylenes, propylene-isobutylene copolymers, chlorinated polybutylenes, poly(1-hexenes), poly(1-octenes), poly(1-decenes), and the like and mixtures thereof; alkylbenzenes such as dodecylbenzenes, tetradecylbenzenes, dinonylbenzenes, di(2-ethylhexyl)-benzenes, and the like; polyphenyls such as biphenyls, terphenyls, alkylated polyphenyls, and the like; alkylated diphenyl ethers and alkylated diphenyl sulfides and the derivative, analogs and homologs thereof and the like.

Other useful synthetic lubricating oils include, but are not limited to, oils made by polymerizing olefins of less than 5 carbon atoms such as ethylene, propylene, butylenes, isobutene, pentene, and mixtures thereof. Methods of preparing such polymer oils are well known to those skilled in the art.

Additional useful synthetic hydrocarbon oils include liquid polymers of alpha olefins having the proper viscosity. Especially useful synthetic hydrocarbon oils are the hydrogenated liquid oligomers of C₆ to C₁₂ alpha olefins such as, for example, 1-decene trimer.

Another class of useful synthetic lubricating oils includes, but is not limited to, alkylene oxide polymers, i.e., homopolymers, interpolymers, and derivatives thereof where the terminal hydroxyl groups have been modified by, for example, esterification or etherification. These oils are exemplified by the oils prepared through polymerization of ethylene oxide or propylene oxide, the alkyl and phenyl ethers of these polyoxyalkylene polymers (e.g., methyl poly propylene glycol ether having an average molecular weight of 1,000, diphenyl ether of polyethylene glycol having a molecular weight of 500 to 1000, diethyl ether of polypropylene glycol having a molecular weight of 1,000 to 1,500, etc.) or mono- and polycarboxylic esters thereof such as, for example, the acetic esters, mixed C₃ to C₈ fatty acid esters, or the C₁₃ oxo acid diester of tetraethylene glycol.

Yet another class of useful synthetic lubricating oils include, but are not limited to, the esters of dicarboxylic acids e.g., phthalic acid, succinic acid, alkyl succinic acids, alkenyl succinic acids, maleic acid, azelaic acid, suberic acid, sebacic acid, fumaric acid, adipic acid, linoleic acid dimer, malonic acids, alkyl malonic acids, alkenyl malonic acids, etc., with a variety of alcohols, e.g., butyl alcohol, hexyl alcohol, dodecyl alcohol, 2-ethylhexyl alcohol, ethylene glycol, diethylene glycol monoether, propylene glycol, etc. Specific examples of these esters include dibutyl adipate, di(2-ethylhexyl)sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, the complex ester formed by reacting one mole of sebacic acid with two moles of tetraethylene glycol and two moles of 2-ethylhexanoic acid and the like.

Esters useful as synthetic oils also include, but are not limited to, those made from carboxylic acids having from about 5 to about 12 carbon atoms with alcohols, e.g., methanol, ethanol, etc., polyols and polyol ethers such as neopentyl glycol, trimethylol propane, pentaerythritol, dipentaerythritol, tripentaerythritol, and the like.

Silicon-based oils such as, for example, polyalkyl-, polyaryl-, polyalkoxy- or polyaryloxy-siloxane oils and silicate oils, comprise another useful class of synthetic lubricating oils. Specific examples of these include, but are not limited to, tetraethyl silicate, tetra-isopropyl silicate, tetra-(2-ethylhexyl) silicate, tetra-(4-methyl-hexyl)silicate, tetra-(p-tert-butylphenyl)silicate, hexyl-(4-methyl-2-pentoxy)disiloxane, poly(methyl)siloxanes, poly(methylphenyl)siloxanes, and the like. Still yet other useful synthetic lubricating oils include, but are not limited to, liquid esters of phosphorous containing acids, e.g., tricresyl phosphate, trioctyl phosphate, diethyl ester of decane phosphionic acid, etc., polymeric tetrahydrofurans and the like.

The lubricating oil may be derived from unrefined, refined and rerefined oils, either natural, synthetic or mixtures of two or more of any of these of the type disclosed hereinabove. Unrefined oils are those obtained directly from a natural or synthetic source (e.g., coal, shale, or tar sands bitumen) without further purification or treatment. Examples of unrefined oils include, but are not limited to, a shale oil obtained directly from retorting operations, a petroleum oil obtained directly from distillation or an ester oil obtained directly from an esterification process, each of which is then used without further treatment. Refined oils are similar to the unrefined oils except they have been further treated in one or more purification steps to improve one or more properties. These purification techniques are known to those of skill in the art and include, for example, solvent extractions, secondary distillation, acid or base extraction, filtration, percolation, hydrotreating, dewaxing, etc. Rerefined oils are obtained by treating used oils in processes similar to those used to obtain refined oils. Such rerefined oils are also known as reclaimed or reprocessed oils and often are additionally processed by techniques directed to removal of spent additives and oil breakdown products.

Lubricating oil base stocks derived from the hydroisomerization of wax may also be used, either alone or in combination with the aforesaid natural and/or synthetic base stocks. Such wax isomerate oil is produced by the hydroisomerization of natural or synthetic waxes or mixtures thereof over a hydroisomerization catalyst.

Natural waxes are typically the slack waxes recovered by the solvent dewaxing of mineral oils; synthetic waxes are typically the wax produced by the Fischer-Tropsch process. Examples of useful oils of lubricating viscosity include HVI and XI-IVI basestocks, such isomerized wax base oils and UCBO (Unconventional Base Oils) base oils.

The heavy duty diesel engine lubricating oil compositions will further contain a minor effective amount of a ashless friction modifier which is a reaction product of a C₄ to about C₇₅, preferably about C₆ to about C₂₄ and more preferably about C₈ to about C₂₂ fatty acid ester, and ammonia or a mono- or di-hydroxy hydrocarbylamine. In one embodiment, the ashless friction modifier contains compounds of the following structure

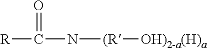

wherein R is a hydrocarbyl group having from about 4 to about 75, preferably from about 6 to about 24, and most preferably from about 8 to about 22, carbon atoms; R′ is a divalent alkylene group having from 1 to about 10, preferably from about 1 to 6, more preferably from about 2 to 5, and most preferably from about 2 to 3, carbon atoms; and a is an integer from about 0 to 2. In one embodiment, a is 0.

Examples of desirable ashless friction modifiers suitable for the present invention include, but are not limited to, octyl amide (capryl amide), nonyl amide, decyl amide (caprin amide), undecyl amide dodecyl amide (lauryl amide), tridecyl amide, teradecyl amide (myristyl amide), pentadecyl amide, hexadecyl amide (palmityl amide), heptadecyl amide, octadecyl amide (stearyl amide), nonadecyl amide, eicosyl amide (alkyl amide), or docosyl amide (behenyl amide). Examples of desirable alkenyl amides include, but are not limited to, palmitoolein amide, oleyl amide, isooleyl amide, elaidyl amide, linolyl amide, linoleyl amide. In a preferred embodiment, the alkyl or alkenyl amide is a coconut oil fatty acid amide.

The acid moiety may be RCO— wherein R is preferably an alkyl or alkenyl hydrocarbon group containing from about 5 to about 19 carbon atoms typified by caprylic, caproic, capric, lauric, myristic, palmitic, stearic, oleic, linoleic, etc. In one embodiment, the acid is saturated although unsaturated acid may be present.

In one embodiment, the reactant bearing the acid moiety may be natural oil: coconut, babassu, palm kernel, palm, olive, castor, peanut, rape, beef tallow, lard, lard oil, whale blubber, sunflower, etc. Typically, the oils which may be employed will contain several acid moieties, the number and type varying with the source of the oil. The acid moiety may be supplied in a fully esterfied compound or one which is less than fully esterfied, e.g., glyceryl tri-stearate, or glyceryl di-laurate and glyceryl mono-oleate, respectively. Esters of polyols including diols and polyalkylene glycols can also be employed such as, for example, esters of mannitol, sorbitol, pentaerytherol, polyoxyethylene polyol and the like.

In one embodiment, the reactant bearing the acid moiety may be a lower alcohol ester, especially a methyl ester, of a natural oil or carboxylic acid. Such reactants may be advantageous in that the resultant reaction product does not contain glycerol, while the lower alcohol evolved in the reaction may easily be distilled from the reaction product.

Ammonia or a mono- or di-hydroxy hydrocarbyl amine with a primary or secondary amine nitrogen may be reacted to form the ashless friction modifier. Typically, the mono- or di-hydroxy hydrocarbyl amines may be characterized by the formula:

HN(R′OH)_{2-b}Hb

wherein R′ has the aforestated meaning and “b” is 0 or 1.

Suitable amines include, but are not limited to, ethanolamine, diethanolamine, propanolamine, isopropanolamine, dipropanolamine, di-isopropanolamine, butanolamine, etc.

The reaction may be effected by heating the oil containing the acid moiety and the amine in equivalent quantities to produce the desired product. Reaction may typically be effected by maintaining the reactants at a temperature of from about 100° C. to 200° C., and preferably from about 120° C. to about 150° C. for about 1 to about 10 hours, and preferably about 4 hours. The reaction can be solventless or carried out in a solvent, preferably one which is compatible with the ultimate composition in which the product is to be used.

In a preferred embodiment the molar ratio of fatty acid ester to mono- or dialkanolamine reactants is chosen to minimize the amount of free mono- or dialkanolamine reactant in the reaction product. Typically, a ratio of fatty acid ester to mono- or dialkanolamine reactants of about 1:1 to about 2:1 is preferred, especially a approximately equimolar ratio.

Typical reaction products which may be employed in the practice of this invention may include those formed from esters having the following acid moieties and alkanolamines:

TABLE I

| Acid Moiety in Ester | Alkanolamine |
|---|---|
| Lauric Acid | Propanolamine |
| Lauric Acid | Diethanolamine |
| Lauric Acid | Ethanolamine |
| Lauric Acid | Dipropanolamine |
| Palmitic Acid | Diethanolamine |
| Palmitic Acid | Ethanolamine |
| Stearic Acid | Diethanolamine |
| Stearic Acid | Ethanolamine |

Other useful mixed reaction products with mono- or dialkanolamines may be formed from the acid component of the following oils: coconut, babassu, palm kernel, palm, olive, castor, peanut, rape, beef tallow, lard, whale blubber, corn, tall, cottonseed, etc.

In one preferred embodiment, the desired reaction product may be prepared by the reaction of (i) a fatty acid ester of a polyhydroxy compound (wherein some or all of the OH groups are esterified) and (ii) diethanolamine.

Typical fatty acid esters may include esters of the fatty acids containing from about 6 to about 20, preferably from about 8 to about 16, and more preferably about 12, carbon atoms. These acids may be characterized by the formula RCOOH wherein R is an alkyl hydrocarbon group containing from about 7 to about 15, preferably from about 11 to about 13, and more preferably about 11 carbon atoms.

In one embodiment, the fatty acid esters which may be employed include glyceryl tri-laurate, glyceryl tri-stearate, glyceryl tri-palmitate, glyceryl di-laurate, glyceryl mono-stearate, ethylene glycol di-laurate, pentaerythritol tetra-stearate, pentaerythritol tri-laurate, sorbitol mono-palmitate, sorbitol penta-stearate, propylene glycol mono-stearate.

In another embodiment, the esters may include those wherein the acid moiety is a mixture as is typified by the following natural oils: coconut, babassu, palm kernel, palm, olive, caster, peanut, rape, beef tallow, lard (leaf), lard oil, whale blubber.

In one preferred embodiment, the fatty acid ester is coconut oil which contains the following acid moieties shown in Table II:

TABLE II

| Fatty Acid Moiety | Weight Percent |
|---|---|
| Caprylic | 8.0 |
| Capric | 7.0 |
| Lauric | 48.0 |
| Myristic | 17.5 |
| Palmitic | 8.2 |
| Stearic | 2.0 |
| Oleic | 6.0 |
| Linoleic | 2.5 |

Representative of the preparation of the reaction product is the preparation disclosed in U.S. Pat. No. 4,729,769, the contents of which are incorporated herein by reference.

In another preferred embodiment the desired reaction product may be prepared by the reaction of (i) a fatty acid methyl ester and (ii) diethanolamine.

It will be readily understood and appreciated by those skilled in the art that the reaction product constitutes a complex mixture of compounds including at least fatty amides, fatty acid esters, fatty acid ester-amides, unreacted starting reactants, free fatty acids, amines, glycerol, and partial fatty acid esters of glycerol (i.e., mono- and di-glycerides). For example, fatty amides are formed when the amine group of the alkanolamine reacts with the carboxyl group of a fatty acid while fatty acid esters are formed when one or more hydroxyl groups of the alkanolamine react with the carboxyl group of a fatty acid. Fatty acid ester-amides are formed when both the amine and hydroxyl group of alkanolamine react with carboxyl groups of fatty acids. In general, a representation of the various amounts of the various compounds constituting the complex mixture of the reaction product is as follows: about 5 to about 65 mole % of fatty amide, about 3 to about 30 mole % fatty acid ester, about 5 to about 65 mole % fatty acid ester-amide, about 0.1 to about 50 mole % partial fatty acid ester, about 0.1 to about 30 mole % glycerol, about 0.1 to about 30 mole % free fatty acids, about 0.1 to about 30 mole % charge alkanolamine, about 0.1 to about 30 mole % charge glycerides, etc. It is not necessary to isolate one or more specific components of the product mixture. Indeed, the reaction product mixture is preferably employed as is in the additive composition of this invention.

In general, the minor effective amount of the ashless friction modifiers present in the heavy duty diesel engine lubricating oil composition will ordinarily range from about 0.05 to about 2 wt. %, based on the total weight of the lubricating oil composition. In another embodiment, the minor effective amount of the ashless friction modifiers present in the heavy duty diesel engine lubricating oil composition will ordinarily range from about 0.25 to about 1 wt. %, based on the total weight of the lubricating oil composition.

The heavy duty diesel engine lubricating oil compositions may also contain conventional heavy duty diesel engine lubricating oil composition additives for imparting auxiliary functions to give a finished heavy duty diesel engine lubricating oil composition in which these additives are dispersed or dissolved. For example, the heavy duty diesel engine lubricating oil compositions can be blended with antioxidants, ashless dispersants, anti-wear agents, detergents such as metal detergents, rust inhibitors, dehazing agents, demulsifying agents, metal deactivating agents, pour point depressants, antifoaming agents, co-solvents, package compatibilisers, corrosion-inhibitors, dyes, extreme pressure agents and the like and mixtures thereof. A variety of the additives are known and commercially available. These additives, or their analogous compounds, can be employed for the preparation of the lubricating oil compositions of the invention by the usual blending procedures.

Representative examples of antioxidants include, but are not limited to, aminic types, e.g., diphenylamine, phenyl-alpha-napthyl-amine, N,N-di(alkylphenyl) amines; and alkylated phenylene-diamines; phenolics such as, for example, BHT, sterically hindered alkyl phenols such as 2,6-di-tert-butylphenol, 2,6-di-tert-butyl-p-cresol and 2,6-di-tert-butyl-4-(2-octyl-3-propanoic) phenol; and mixtures thereof.

Representative examples of ashless dispersants include, but are not limited to, amines, alcohols, amides, or ester polar moieties attached to the polymer backbones via bridging groups. An ashless dispersant of the present invention may be, for example, selected from oil soluble salts, esters, amino-esters, amides, imides, and oxazolines of long chain hydrocarbon substituted mono and dicarboxylic acids or their anhydrides; thiocarboxylate derivatives of long chain hydrocarbons, long chain aliphatic hydrocarbons having a polyamine attached directly thereto; and Mannich condensation products formed by condensing a long chain substituted phenol with formaldehyde and polyalkylene polyamine.

Carboxylic dispersants are reaction products of carboxylic acylating agents (acids, anhydrides, esters, etc.) comprising at least about 34 and preferably at least about 54 carbon atoms with nitrogen containing compounds (such as amines), organic hydroxy compounds (such as aliphatic compounds including monohydric and polyhydric alcohols, or aromatic compounds including phenols and naphthols), and/or basic inorganic materials. These reaction products include imides, amides, and esters.

Succinimide dispersants are a type of carboxylic dispersant. They are produced by reacting hydrocarbyl-substituted succinic acylating agent with organic hydroxy compounds, or with amines comprising at least one hydrogen atom attached to a nitrogen atom, or with a mixture of the hydroxy compounds and amines. The term “succinic acylating agent” refers to a hydrocarbon-substituted succinic acid or a succinic acid-producing compound, the latter encompasses the acid itself. Such materials typically include hydrocarbyl-substituted succinic acids, anhydrides, esters (including half esters) and halides.

Succinic-based dispersants have a wide variety of chemical structures. One class of succinic-based dispersants may be represented by the formula:

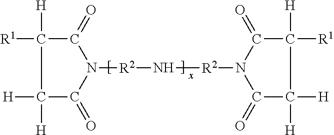

wherein each R¹ is independently a hydrocarbyl group, such as a polyolefin-derived group. Typically the hydrocarbyl group is an alkyl group, such as a polyisobutyl group. Alternatively expressed, the R¹ groups can contain about 40 to about 500 carbon atoms, and these atoms may be present in aliphatic forms. R² is an alkylene group, commonly an ethylene (C₂H₄) group. Examples of succinimide dispersants include those described in, for example, U.S. Pat. Nos. 3,172,892, 4,234,435 and 6,165,235.

The polyalkenes from which the substituent groups are derived are typically homopolymers and interpolymers of polymerizable olefin monomers of 2 to about 16 carbon atoms, and usually 2 to 6 carbon atoms. The amines which are reacted with the succinic acylating agents to form the carboxylic dispersant composition can be monoamines or polyamines.

Succinimide dispersants are referred to as such since they normally contain nitrogen largely in the form of imide functionality, although the amide functionality may be in the form of amine salts, amides, imidazolines as well as mixtures thereof. To prepare a succinimide dispersant, one or more succinic acid-producing compounds and one or more amines are heated and typically water is removed, optionally in the presence of a substantially inert organic liquid solvent/diluent. The reaction temperature can range from about 80° C. up to the decomposition temperature of the mixture or the product, which typically falls between about 100° C. to about 300° C. Additional details and examples of procedures for preparing the succinimide dispersants of the present invention include those described in, for example, U.S. Pat. Nos. 3,172,892, 3,219,666, 3,272,746, 4,234,435, 6,165,235 and 6,440,905.

Suitable ashless dispersants may also include amine dispersants, which are reaction products of relatively high molecular weight aliphatic halides and amines, preferably polyalkylene polyamines. Examples of such amine dispersants include those described in, for example, U.S. Pat. Nos. 3,275,554, 3,438,757, 3,454,555 and 3,565,804.

Suitable ashless dispersants may further include “Mannich dispersants,” which are reaction products of alkyl phenols in which the alkyl group contains at least about 30 carbon atoms with aldehydes (especially formaldehyde) and amines (especially polyalkylene polyamines). Examples of such dispersants include those described in, for example, U.S. Pat. Nos. 3,036,003, 3,586,629, 3,591,598 and 3,980,569.

Suitable ashless dispersants may also be post-treated ashless dispersants such as post-treated succinimides, e.g., post-treatment processes involving borate or ethylene carbonate as disclosed in, for example, U.S. Pat. Nos. 4,612,132 and 4,746,446; and the like as well as other post-treatment processes. The carbonate-treated alkenyl succinimide is a polybutene succinimide derived from polybutenes having a molecular weight of about 450 to about 3000, preferably from about 900 to about 2500, more preferably from about 1300 to about 2400, and most preferably from about 2000 to about 2400, as well as mixtures of these molecular weights. Preferably, it is prepared by reacting, under reactive conditions, a mixture of a polybutene succinic acid derivative, an unsaturated acidic reagent copolymer of an unsaturated acidic reagent and an olefin, and a polyamine, such as disclosed in U.S. Pat. No. 5,716,912, the contents of which are incorporated by reference herein.

Suitable ashless dispersants may also be polymeric, which are interpolymers of oil-solubilizing monomers such as decyl methacrylate, vinyl decyl ether and high molecular weight olefins with monomers containing polar substitutes. Examples of polymeric dispersants include those described in, for example, U.S. Pat. Nos. 3,329,658; 3,449,250 and 3,666,730.

In one preferred embodiment of the present invention, an ashless dispersant for use in the lubricating oil composition is a bis-succinimide derived from a polyisobutenyl group having a number average molecular weight of about 700 to about 2300. The dispersant(s) for use in the lubricating oil compositions of the present invention are preferably non-polymeric (e.g., are mono- or bis-succinimides).

Generally, the one or more ashless dispersants are present in the heavy duty diesel engine lubricating oil composition in an amount ranging from about 0.01% by weight to about 10% by weight, based on the total weight of the lubricating oil composition.

Representative examples of antiwear agents include, but are not limited to, zinc dialkyldithiophosphates and zinc diaryldithiophosphates, e.g., those described in an article by Born et al. entitled “Relationship between Chemical Structure and Effectiveness of Some Metallic Dialkyl- and Diaryl-dithiophosphates in Different Lubricated Mechanisms”, appearing in Lubrication Science 4-2 Jan. 1992, see for example pages 97-100; aryl phosphates and phosphites, sulfur-containing esters, phosphosulfur compounds, metal or ash-free dithiocarbamates, xanthates, alkyl sulfides and the like and mixtures thereof.

Representative examples of metal detergents include sulphonates, alkylphenates, sulfurized alkyl phenates, carboxylates, salicylates, phosphonates, and phosphinates. Commercial products are generally referred to as neutral or overbased. Overbased metal detergents are generally produced by carbonating a mixture of hydrocarbons, detergent acid, for example: sulfonic acid, alkylphenol, carboxylate etc., metal oxide or hydroxides (for example calcium oxide or calcium hydroxide) and promoters such as xylene, methanol and water. For example, for preparing an overbased calcium sulfonate, in carbonation, the calcium oxide or hydroxide reacts with the gaseous carbon dioxide to form calcium carbonate. The sulfonic acid is neutralized with an excess of CaO or Ca(OH)₂, to form the sulfonate.

Metal-containing or ash-forming detergents function as both detergents to reduce or remove deposits and as acid neutralizers or rust inhibitors, thereby reducing wear and corrosion and extending engine life. Detergents generally comprise a polar head with a long hydrophobic tail. The polar head comprises a metal salt of an acidic organic compound. The salts may contain a substantially stoichiometric amount of the metal in which case they are usually described as normal or neutral salts, and would typically have a total base number or TBN (as can be measured by ASTM D2896) of from 0 to about 80. A large amount of a metal base may be incorporated by reacting excess metal compound (e.g., an oxide or hydroxide) with an acidic gas (e.g., carbon dioxide). The resulting overbased detergent comprises neutralized detergent as the outer layer of a metal base (e.g., carbonate) micelle. Such overbased detergents may have a TBN of about 150 or greater, and typically will have a TBN of from about 250 to about 450 or more.

Detergents that may be used include oil-soluble neutral and overbased sulfonates, phenates, sulfurized phenates, thiophosphonates, salicylates, and naphthenates and other oil-soluble carboxylates of a metal, particularly the alkali or alkaline earth metals, e.g., barium, sodium, potassium, lithium, calcium, and magnesium. The most commonly used metals are calcium and magnesium, which may both be present in detergents used in a lubricant, and mixtures of calcium and/or magnesium with sodium. Particularly convenient metal detergents are neutral and overbased calcium sulfonates having TBN of from about 20 to about 450, neutral and overbased calcium phenates and sulfurized phenates having TBN of from about 50 to about 450 and neutral and overbased magnesium or calcium salicylates having a TBN of from about 20 to about 450. Mixtures of detergents, whether overbased or neutral or both, may be used.

In one embodiment, the detergent can be one or more alkali or alkaline earth metal salts of an alkyl-substituted hydroxyaromatic carboxylic acid. Suitable hydroxyaromatic compounds include mononuclear monohydroxy and polyhydroxy aromatic hydrocarbons having 1 to 4, and preferably 1 to 3, hydroxyl groups. Suitable hydroxyaromatic compounds include phenol, catechol, resorcinol, hydroquinone, pyrogallol, cresol, and the like. The preferred hydroxyaromatic compound is phenol.

The alkyl substituted moiety of the alkali or alkaline earth metal salt of an alkyl-substituted hydroxyaromatic carboxylic acid is derived from an alpha olefin having from about 10 to about 80 carbon atoms. The olefins employed may be linear, isomerized linear, branched or partially branched linear. The olefin may be a mixture of linear olefins, a mixture of isomerized linear olefins, a mixture of branched olefins, a mixture of partially branched linear or a mixture of any of the foregoing.

In one embodiment, the mixture of linear olefins that may be used is a mixture of normal alpha olefins selected from olefins having from about 12 to about 30 carbon atoms per molecule. In one embodiment, the normal alpha olefins are isomerized using at least one of a solid or liquid catalyst.

In another embodiment, the olefins are a branched olefinic propylene oligomer or mixture thereof having from about 20 to about 80 carbon atoms, i.e., branched chain olefins derived from the polymerization of propylene. The olefins may also be substituted with other functional groups, such as hydroxy groups, carboxylic acid groups, heteroatoms, and the like. In one embodiment, the branched olefinic propylene oligomer or mixtures thereof have from about 20 to about 60 carbon atoms. In one embodiment, the branched olefinic propylene oligomer or mixtures thereof have from about 20 to about 40 carbon atoms.

In one embodiment, at least about 75 mole % (e.g., at least about 80 mole %, at least about 85 mole %, at least about 90 mole %, at least about 95 mole %, or at least about 99 mole %) of the alkyl groups contained within the alkali or alkaline earth metal salt of an alkyl-substituted hydroxyaromatic carboxylic acid such as the alkyl groups of an alkaline earth metal salt of an alkyl-substituted hydroxybenzoic acid detergent are a C₂₀ or higher. In another embodiment, the alkali or alkaline earth metal salt of an alkyl-substituted hydroxyaromatic carboxylic acid is an alkali or alkaline earth metal salt of an alkyl-substituted hydroxybenzoic acid that is derived from an alkyl-substituted hydroxybenzoic acid in which the alkyl groups are the residue of normal alpha-olefins containing at least 75 mole % C₂₀ or higher normal alpha-olefins.

In another embodiment, at least about 50 mole % (e.g., at least about 60 mole %, at least about 70 mole %, at least about 80 mole %, at least about 85 mole %, at least about 90 mole %, at least about 95 mole %, or at least about 99 mole %) of the alkyl groups contained within the alkali or alkaline earth metal salt of an alkyl-substituted hydroxyaromatic carboxylic acid such as the alkyl groups of an alkali or alkaline earth metal salt of an alkyl-substituted hydroxybenzoic acid are about C₁₄ to about C₁₈.

The resulting alkali or alkaline earth metal salt of an alkyl-substituted hydroxyaromatic carboxylic acid will be a mixture of ortho and para isomers. In one embodiment, the product will contain about 1 to 99% ortho isomer and 99 to 1% para isomer. In another embodiment, the product will contain about 5 to 70% ortho and 95 to 30% para isomer.

The alkali or alkaline earth metal salts of an alkyl-substituted hydroxyaromatic carboxylic acid can be neutral or overbased. Generally, an overbased alkali or alkaline earth metal salt of an alkyl-substituted hydroxyaromatic carboxylic acid is one in which the BN of the alkali or alkaline earth metal salts of an alkyl-substituted hydroxyaromatic carboxylic acid has been increased by a process such as the addition of a base source (e.g., lime) and an acidic overbasing compound (e.g., carbon dioxide).

Overbased salts may be low overbased, e.g., an overbased salt having a BN below about 100. In one embodiment, the BN of a low overbased salt may be from about 5 to about 50. In another embodiment, the BN of a low overbased salt may be from about 10 to about 30. In yet another embodiment, the BN of a low overbased salt may be from about 15 to about 20.

Overbased detergents may be medium overbased, e.g., an overbased salt having a BN from about 100 to about 250. In one embodiment, the BN of a medium overbased salt may be from about 100 to about 200. In another embodiment, the BN of a medium overbased salt may be from about 125 to about 175.

Overbased detergents may be high overbased, e.g., an overbased salt having a BN above about 250. In one embodiment, the BN of a high overbased salt may be from about 250 to about 450.

Sulfonates may be prepared from sulfonic acids which are typically obtained by the sulfonation of alkyl substituted aromatic hydrocarbons such as those obtained from the fractionation of petroleum or by the alkylation of aromatic hydrocarbons. Examples included those obtained by alkylating benzene, toluene, xylene, naphthalene, diphenyl or their halogen derivatives. The alkylation may be carried out in the presence of a catalyst with alkylating agents having from about 3 to more than 70 carbon atoms. The alkaryl sulfonates usually contain from about 9 to about 80 or more carbon atoms, preferably from about 16 to about 60 carbon atoms per alkyl substituted aromatic moiety.

The oil soluble sulfonates or alkaryl sulfonic acids may be neutralized with oxides, hydroxides, alkoxides, carbonates, carboxylate, sulfides, hydrosulfides, nitrates, borates and ethers of the metal. The amount of metal compound is chosen having regard to the desired TBN of the final product but typically ranges from about 100 to about 220 wt. % (preferably at least about 125 wt. %) of that stoichiometrically required.

Metal salts of phenols and sulfurized phenols are prepared by reaction with an appropriate metal compound such as an oxide or hydroxide and neutral or overbased products may be obtained by methods well known in the art. Sulfurized phenols may be prepared by reacting a phenol with sulfur or a sulfur containing compound such as hydrogen sulfide, sulfur monohalide or sulfur dihalide, to form products which are generally mixtures of compounds in which 2 or more phenols are bridged by sulfur containing bridges.

Generally, the detergents can be present in the heavy duty diesel engine lubricating oil compositions in amount of about 1% by weight to about 15% by weight, based on the total weight of the trunk piston engine lubricating oil composition.

Representative examples of rust inhibitors include, but are not limited to, nonionic polyoxyalkylene agents, e.g., polyoxyethylene lauryl ether, polyoxyethylene higher alcohol ether, polyoxyethylene nonylphenyl ether, polyoxyethylene octylphenyl ether, polyoxyethylene octyl stearyl ether, polyoxyethylene oleyl ether, polyoxyethylene sorbitol monostearate, polyoxyethylene sorbitol monooleate, and polyethylene glycol monooleate; stearic acid and other fatty acids; dicarboxylic acids; metal soaps; fatty acid amine salts; metal salts of heavy sulfonic acid; partial carboxylic acid ester of polyhydric alcohol; phosphoric esters; (short-chain) alkenyl succinic acids; partial esters thereof and nitrogen-containing derivatives thereof; synthetic alkarylsulfonates, e.g., metal dinonylnaphthalene sulfonates; and the like and mixtures thereof.

Representative examples of antifoaming agents include, but are not limited to, polymers of alkyl methacrylate; polymers of dimethylsilicone and the like and mixtures thereof.

Representative examples of a pour point depressant include, but are not limited to, polymethacrylates, alkyl acrylate polymers, alkyl methacrylate polymers, di(tetra-paraffin phenol)phthalate, condensates of tetra-paraffin phenol, condensates of a chlorinated paraffin with naphthalene and mixtures thereof. In one embodiment, a pour point depressant comprises an ethylene-vinyl acetate copolymer, a condensate of chlorinated paraffin and phenol, polyalkyl styrene and the like and mixtures thereof. The amount of the pour point depressant may vary from about 0.01% by weight to about 10% by weight.

Representative examples of a demulsifier include, but are not limited to, anionic surfactants (e.g., alkyl-naphthalene sulfonates, alkyl benzene sulfonates and the like), nonionic alkoxylated alkylphenol resins, polymers of alkylene oxides (e.g., polyethylene oxide, polypropylene oxide, block copolymers of ethylene oxide, propylene oxide and the like), esters of oil soluble acids, polyoxyethylene sorbitan ester and the like and mixtures thereof. The amount of the demulsifier may vary from about 0.01% by weight to about 10% by weight.

Representative examples of a corrosion inhibitor include, but are not limited to, half esters or amides of dodecylsuccinic acid, phosphate esters, thiophosphates, alkyl imidazolines, sarcosines and the like and mixtures thereof. The amount of the corrosion inhibitor may vary from about 0.01% by weight to about 5% by weight.

Representative examples of an extreme pressure agent include, but are not limited to, sulfurized animal or vegetable fats or oils, sulfurized animal or vegetable fatty acid esters, fully or partially esterified esters of trivalent or pentavalent acids of phosphorus, sulfurized olefins, dihydrocarbyl polysulfides, sulfurized Diels-Alder adducts, sulfurized dicyclopentadiene, sulfurized or co-sulfurized mixtures of fatty acid esters and monounsaturated olefins, co-sulfurized blends of fatty acid, fatty acid ester and alpha-olefin, functionally-substituted dihydrocarbyl polysulfides, thia-aldehydes, thia-ketones, epithio compounds, sulfur-containing acetal derivatives, co-sulfurized blends of terpene and acyclic olefins, and polysulfide olefin products, amine salts of phosphoric acid esters or thiophosphoric acid esters and the like and mixtures thereof. The amount of the extreme pressure agent may vary from about 0.01% by weight to about 5% by weight.

Each of the foregoing additives, when used, is used at a functionally effective amount to impart the desired properties to the lubricant. Thus, for example, if an additive is an ashless dispersant, a functionally effective amount of this ashless dispersant would be an amount sufficient to impart the desired dispersancy characteristics to the lubricant. Generally, the concentration of each of these additives, when used, may range, unless otherwise specified, from about 0.001% to about 20% by weight, and in one embodiment about 0.01% to about 10% by weight based on the total weight of the lubricating oil composition.

If desired, the heavy duty diesel engine lubricating oil additives may be provided as an additive package or concentrate in which the additives are incorporated into a substantially inert, normally liquid organic diluent such as, for example, mineral oil, naphtha, benzene, toluene or xylene to form an additive concentrate. These concentrates usually contain from about 20% to about 80% by weight of such diluent. Typically a neutral oil having a viscosity of about 4 to about 8.5 cSt at 100° C. and preferably about 4 to about 6 cSt at 100° C. will be used as the diluent, though synthetic oils, as well as other organic liquids which are compatible with the additives and finished lubricating oil can also be used. The additive package will typically contain one or more of the various additives, referred to above, in the desired amounts and ratios to facilitate direct combination with the requisite amount of the major amount of an oil of lubricating viscosity.

The following non-limiting examples are illustrative of the present invention.

### Example 1

A friction modifier was prepared by reacting methyl cocoate with diethanolamine (at a DEA/methyl cocoate charge mole ratio: 0.9) at approximately 150° C. for about 4 hours. Residual methanol was removed, and the product diluted with C₉ aromatic solvent. A demulsifier was added to form a final product comprised of 75% friction modifier, 23% aromatic solvent, and 2% demulsifier.

### Comparative Oil A

A typical heavy duty diesel engine oil was prepared as a baseline oil for testing. This oil contained typical amounts of dispersants, detergents, antioxidants, zinc dithiophosphate, foam inhibitor, pour point depressant and dispersant VII.

### Oil 1

A lubricating oil composition was prepared by top-treating the 100 parts by weight of the Comparative Oil A with 2 parts by weight of the reaction product of Example 1.

### Comparative Oil B

A lubricating oil composition was prepared by top-treating 100 parts by weight of Comparative Oil A with 1.6 parts by weight of a molybdenum dithiocarbamate additive, a known friction modifier, to obtain a final treat rate of 1000 ppm molybdenum.

Testing

MTM Friction Testing of Heavily Sooted Oils—at Different Sliding Speeds

Evaluation of Friction Performance

The lubricating oil compositions of Oil 1 and Comparative Oil A were tested for their friction performance in a Mini Traction Machine (MTM) bench test. In this bench test, friction performance is measured as the coefficient of friction (CoF) at a given sliding speed. A lower CoF corresponds to better friction performance of the oil. The MTM apparatus is manufactured by PCS Instruments and operates with a ball (¼″ diameter, 52100 steel) loaded against a rotating disk (52100 steel). The conditions employ a load of approximately 14 N, a speed of approximately 5 to 3800 mm/s (in ten minute intervals of 3800, 2000, 1000, 100, 20, 10, and 5 mm/s), a temperature of approximately 116° C., and 9% (as total lubricant mass) added soot, i.e., 91 grams of test oil +9 grams of soot.

The soot that is added to the test oil is obtained from the exhaust of diesel test engines. The soot is washed with solvent prior to addition to the oil. The soot is added to the oil to be tested using a homogenizer, just before the friction is tested.

The average CoF at 7 different sliding speeds is shown below in Table III for Oils 1 and Comparative Oil A.

TABLE III
MTM data for varying sliding speeds

| Sliding | Avg. CoF | Avg. CoF |
|---|---|---|
| Speed (mm/s) | Oil 1 | Comparative Oil A |
| 3800 | 0.110 | 0.102 |
| 2000 | 0.134 | 0.124 |
| 1000 | 0.138 | 0.143 |
| 100 | 0.150 | 0.171 |
| 20 | 0.141 | 0.168 |
| 10 | 0.132 | 0.174 |
| 5 | 0.126 | 0.178 |

The data demonstrate that the lubricating oil composition top-treated with the friction modifier according to the present invention provided reduced friction in a heavily sooted environment in the case of lower sliding speeds where friction reducing properties are particularly desirable.

mass) added soot, i.e. 91 grams of test oil +9 grams of soot. The test duration was 70 minutes. In this bench test, friction performance is measured as CoF as a function of time. A lower CoF corresponds to better friction performance of the oil. The average CoF for the three different oils are shown below in Table IV.

TABLE IV
MTM data for 5 mm/s sliding speed

| Oil | Comparative Oil A | Comparative Oil B | Oil 1 |
|---|---|---|---|
| Average CoF | 0.175 | 0.157 | 0.121 |

The results demonstrate that a lubricating oil composition of Oil 1 containing the friction modifier according to the present invention provide reduced friction in a heavily sooted environment as compared to the baseline formulation of Comparative Oil A. Further, the lubricating oil composition of Oil 1 containing the friction modifier according to the present invention provide significantly reduced friction in a heavily sooted environment as compared to the lubricating oil composition of Comparative Oil B containing molybdenum dithiocarbamate as a known friction modifier.

Fuel Economy Testing of Lightly Sooted Oils in a Toyota 2ZR-FE Engine

The lubricating oil compositions of Comparative Oils A and B as well as Oil 1 were tested for their fuel economy performance in a gasoline engine test. Gasoline engines are known to produce very little if any measurable amounts of soot during operation. The engine is a Toyota 2ZR-FE 1.8 L in-line 4 cylinder arrangement. The torque meter is positioned between the motor and the crank shaft of the engine and the % torque change is measured between a reference and candidate oil. % torque change data at oil temperatures of 100° C. and 80° C. and engine speeds of 750 to 2000 RPM are measured. Lower % torque change reflects better fuel economy. The torque data for this test is set forth below in Table V.

TABLE V

| | 100° C. | 100° C. | 80° C. | 80° C. |
|---|---|---|---|---|
| | 1750 RPM | 2000 RPM | 750 RPM | 850 RPM |
| Comparative Oil A | 3.00% | 3.20% | 2.05% | 2.56% |
| Comparative Oil B | 1.46% | 1.83% | 0.36% | 0.79% |
| Oil 1 | 1.83% | 2.12% | 0.71% | 1.43% |

The results demonstrate that the lubricating oil composition of Oil 1 containing the friction modifier according to the present invention does not provide reduced friction in a lightly sooted environment as compared to the lubricating oil composition of Comparative Oil B containing known molybdenum dithiocarbamate as a friction modifier. Thus, the data show that it is unpredictable as to how a friction modifier will perform in a heavily sooted heavy duty diesel engine.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A method for improving the fuel economy of a heavy duty diesel engine which produces a heavily sooted lubricating oil composition during the engine's normal operation, the method comprising lubricating the heavy duty diesel engine with a lubricating oil composition comprising (a) a major amount of an oil of lubricating viscosity; and (b) a minor effective amount of an ashless friction modifier comprising a reaction product of a C₄ to about C₇₅ fatty acid ester and a mono- or dialkanolamine.

2. The method of claim 1, wherein the fatty acid ester is an about C₆ to about C₂₄ fatty acid ester.

3. The method of claim 1, wherein the fatty acid ester is a glycerol fatty acid ester.

4. The method of claim 3, wherein the glycerol fatty acid ester is selected from the group consisting of palm, olive, cotton seed, castor, peanut, tallow, lard, whale, sunflower, soybean, coconut, palm kernel oils and combinations thereof.

5. The method of claim 1, wherein the mono- or dialkanolamine possesses the general formula:
RN(R′OH)₂₋ₐHₐ
wherein R is hydrogen, a C₁ to C₃₀ hydrocarbyl group or an aminoalkyl group with the alkyl having from one to about six carbon atoms, R′ is a C₂ to C₆ hydrocarbyl group and “a” is 0 or 1, with the proviso that R is hydrogen when “a” is 0.

6. The method of claim 1, wherein the mono- or dialkanolamine is selected from the group consisting of monoethanolamine, diethanolamine, propanolamine, isopropanolamine, dipropanolamine, di-isopropanolamine, butanolamines, aminoethylaminoethanol and combinations thereof.

7. The method of claim 1, wherein the ashless friction modifier is the reaction product of a fatty acid ester selected from the group consisting of palm, olive, cotton seed, castor, peanut, tallow, lard, whale, sunflower, soybean, coconut, palm kernel oils and combinations thereof and an alkanolamine selected from the group consisting of monoethanolamine, diethanolamine, propanolamine, isopropanolamine, dipropanolamine, di-isopropanolamine, butanolamines, aminoethylaminoethanol and combinations thereof.

8. The method of claim 1, wherein the minor effective amount of the ashless friction modifier present in the heavy duty diesel engine lubricating oil composition is from about 0.05 to about 2 weight percent, based on the total weight of the heavy duty diesel engine lubricating oil composition.

9. The method of claim 1, wherein the minor effective amount of the ashless friction modifier present in the heavy duty diesel engine lubricating oil composition is from about 0.25 to about 1 weight percent, based on the total weight of the heavy duty diesel engine lubricating oil composition.

10. The method of claim 1, wherein the heavy duty diesel engine lubricating oil composition further comprises one or more heavy duty diesel engine lubricating oil additives selected from the group consisting of an ashless dispersant, antioxidant, rust inhibitor, dehazing agent, demulsifying agent, metal deactivating agent, friction modifier, pour point depressant, antifoaming agent, co-solvent, package compatibiliser, corrosion-inhibitor, dye, extreme pressure agent and mixtures thereof.

11. The method of claim 1, wherein the heavy duty diesel engine is a light heavy duty diesel engine.

12. The method of claim 1, wherein the heavy duty diesel engine is a medium heavy duty diesel engine.

13. The method of claim 1, wherein the heavy duty diesel engine is a heavy heavy duty diesel engine.

14. The method of claim 1, wherein the heavy duty diesel engine produces a soot loading for the heavy duty diesel engine lubricating oil composition of at least 2 wt. % after 20,000 miles of normal operation.

15. The method of claim 1, wherein the heavy duty diesel engine produces a soot loading for the heavy duty diesel engine lubricating oil composition of at least 2 wt. % to no more than about 9 wt. % after 20,000 miles of normal operation.

16. The method of claim 1, wherein the heavy duty diesel engine produces a soot loading for the heavy duty diesel engine lubricating oil composition of at least 2 wt. % to no more than about 5 wt. % after 20,000 miles of normal operation.

17. The method of claim 1, wherein the heavy duty diesel engine produces a soot loading for the heavy duty diesel engine lubricating oil composition of at least about 3 wt. % to no more than about 9 wt. % after 20,000 miles of normal operation.

18. The method of claim 1, wherein the heavy duty diesel engine produces a soot loading for the heavy duty diesel engine lubricating oil composition of at least about 3 wt. % to no more than about 5 wt. % after 20,000 miles of normal operation.

19. The method of claim 1, wherein the heavy duty diesel engine produces a soot loading for the heavy duty diesel engine lubricating oil composition of at least about 3 wt. % to no more than about 4 wt. % after 20,000 miles of normal operation.

20. The method of claim 1, wherein the heavy duty diesel engine is a heavy duty diesel engine which produces a soot loading for the heavy duty diesel engine lubricating oil composition of at least about 3 wt. % to no more than about 9 wt. % after 20,000 miles of normal operation.
